(19) United States
(12) Patent Application Publication
(10) Pub. No.: US 2009/0226661 A1
(43) Pub. Date: Sep. 10, 2009

(54) FLOOR COVERINGS AND METHODS OF MAKING AND USING

(76) Inventor: Yannick Laurent, Neuchatel (CH)

Correspondence Address: DLA PIPER LLP (US);ATTN: PATENT GROUP, P.O. Box 2758, Reston, VA, 20195, US

(21) Appl. No.: 12/092,688

(22) PCT Filed: Nov. 3, 2006
(86) PCT No.: PCT/US06/43064

§ 371 Date: Oct. 20, 2008

Related U.S. Application Data
(60) Provisional application No. 60/732,699, filed on Nov. 3, 2005.

(51) Int. Cl. B32B 3/02; B05D 3/02

(52) U.S. Cl. 428/88; 428/92; 427/385.5

(57) ABSTRACT

A floor covering, which comprises at least one pile layer comprising: at least a first upper surface portion in which a plurality of pile layer fibers are in contact with a reinforcing composition comprising polymerized copolyamide, polymerized copolyester, or a combination thereof; and at least a second upper surface portion in which a plurality of pile layer fibers are not in contact with the composition.

This application is based on U.S. Provisional Application Ser. No. 60/732,699, filed Nov. 3, 2005, the entire contents of which are hereby incorporated by reference.

### BACKGROUND

The present invention generally relates to floor coverings, for example, mats, rugs, carpets, and the like, methods for making and treating same, and methods for using.

### DESCRIPTION OF THE DRAWINGS

FIG. 1 shows a cross sectional view of one embodiment of the invention.

FIG. 2 shows a cross sectional view of another embodiment of the invention.

FIG. 3 shows a cross sectional view of another embodiment of the invention.

FIG. 4 shows a cross sectional view of another embodiment of the invention.

FIG. 5 shows a cross sectional view of another embodiment of the invention.

FIG. 6 shows a cross sectional view of another embodiment of the invention.

FIG. 7 shows a cross sectional view of another embodiment of the invention.

FIG. 8 shows a cross sectional view of another embodiment of the invention.

FIG. 9 shows a cross sectional view of another embodiment of the invention.

FIG. 10 shows a cross sectional view of another embodiment of the invention.

FIG. 11 shows a plan view of another embodiment of the invention.

FIG. 12 shows a cross-sectional view along section “B” of FIG. 11.

FIG. 13 shows a perspective drawing of one embodiment for carrying out the invention.

FIG. 14 shows the results of an abrasion test on a mat not in accordance with the invention.

### BRIEF DESCRIPTION OF THE SEVERAL EMBODIMENTS

One embodiment provides a floor covering suitable for use in automobiles, homes, and anywhere a floor covering is needed. The floor covering may be used over one or more types of floors such as carpeted floors, wood floors, cement floors, tile floors, and the like.

The floor covering may or may not be pliable, e.g., it may be stiff or inflexible or it may be easily folded or flexed. For example, a floor mat held at arms length which is unable to support its own weight would be pliable or a mat which can be rolled up would be pliable.

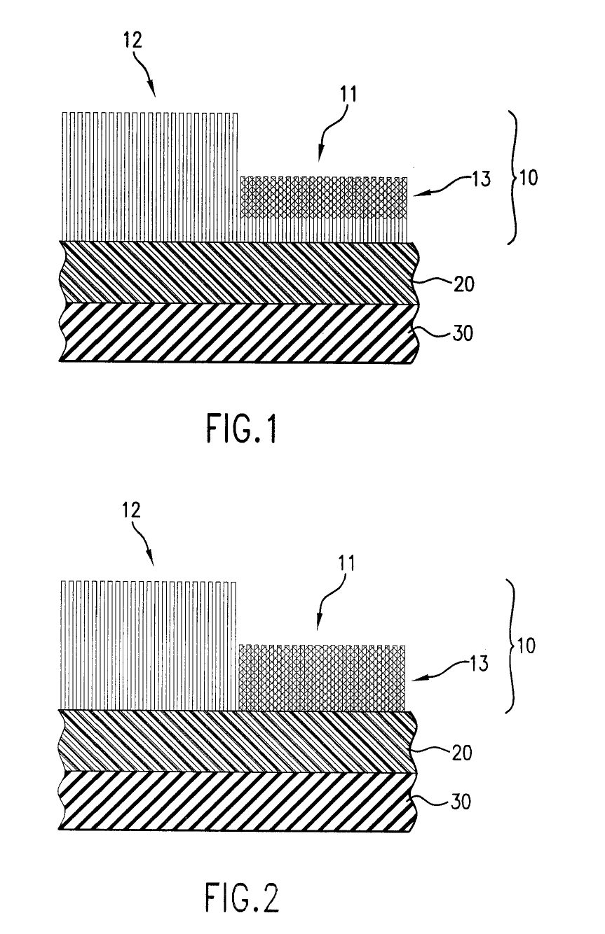

The floor covering may or may not have a multilayer construction. As seen in FIGS. 1-10, it may include a combination of a pile layer 10, optionally one or more backing layers 20, and optionally a base layer 30. In one embodiment, and typical of carpets, the pile layer 10 includes a fibrous material and forms the wearing, upper surface of the floor covering, e.g., the face or nap of the floor covering. The pile layer 10 may be attached to the backing layer 20 by any of various methods. More than one backing layer 20 may be present. In one embodiment, the base layer 30 is the lowermost, floor contacting layer, and it may be made of an elastomeric or other material.

In one embodiment, the first upper surface portion 11 of the pile layer 10 includes a plurality of pile layer fibers that are in contact with a reinforcing composition. See, e.g., FIGS. 1-10. In one embodiment, the first upper surface portion 11 of the pile layer 10 includes a plurality of pile fiber layers that are in contact with a reinforcing composition anywhere along the length of the vertical thickness of the pile layer 10. In one embodiment, the first upper surface portion 11 of the pile layer 10 includes any portion along the vertical thickness of pile layer 10. This includes the uppermost surface of the pile layer 10, an upper region of pile layer 10, a central region of pile layer 10, a lower region of pile layer 10, a lower region of pile layer 10 not in contact with the backing layer 20, a lowermost region of pile layer 10 in direct contact with one or more portions of the backing layer 20, or any combination thereof.

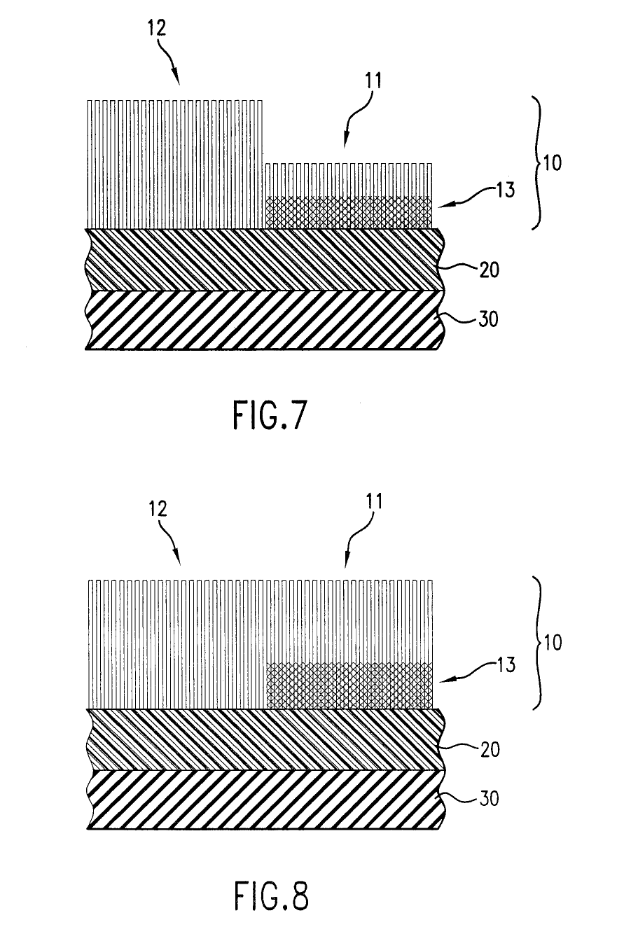

In one embodiment, the uppermost surface of the first upper surface portion 11 of pile layer 10 is not in contact with reinforcing composition, such that an unreinforced portion of the fibers of pile layer 10 forms a wearing surface of the first upper surface portion 11. See, e.g., FIGS. 7-10. In one embodiment, the first upper surface portion 11 comprises the reinforcing composition at a lower portion along the length of the vertical thickness of the pile layer 10. See, e.g., FIGS. 7-8. In one embodiment, the reinforcing composition may be exposed on the uppermost surface of the first upper surface portion 11 such that it forms all or a portion of the wearing surface of the first upper surface portion 11. See, e.g., FIGS. 1-6. In one embodiment, the reinforcing composition is not exposed on the uppermost surface of the first upper surface portion 11 such that it does not form a portion of the wearing surface of the first upper surface portion 11. See, e.g., FIGS. 7-10.

In one embodiment, the reinforcing composition is a hot melt adhesive, such as polymerized copolyamide, polymerized copolyester, or a combination thereof. In one embodiment, the reinforcing composition binds the fibers together. In one embodiment, the first upper surface portion 11 of the pile layer 10 is more wear resistant. In one embodiment, the density of the first upper surface portion 11 of the pile layer 10 is greater than that of the second upper surface portion 12 of the pile layer 10. See, e.g., FIGS. 1-10.

In one embodiment, the reinforcing composition may contact the floor covering at the pile fiber layer 10. In another embodiment, if an edge of the floor covering is serged (not shown), the reinforcing composition may be used on or in contact with the serging and/or the serged edge of the floor covering.

In one embodiment, the second upper surface portion 12 is not in contact with the reinforcing copolyamide or the copolyester. The term not in contact should be understood to mean that the pile fibers of the second upper surface portion are not in contact or substantially not in contact with any reinforcing copolyamide or copolyester beyond that included in the pile fibers themselves (e.g., it is acceptable that the pile fibers that make up the second upper surface portion 12 are made from copolyamide- or copolyester-containing fibers) or that included in the backing layer 20 or base layer 30 (e.g., it is acceptable that those layers are made from copolyamide- or copolyester-containing materials) or that included in any serge area or that along the border or edge between the first and second upper surface portions 11 and 12.

The reinforcing composition may include copolyamide, copolyester, or both. It may exhibit thermoplastic, thermosetting, or thermoplastic elastomeric behavior. It may be crosslinked or non-crosslinked. Any suitable copolyamide and copolyester may be used so long as they adhere to and reinforce the fibers of the pile, serging, or both. One example of copolyester is a copolyethylene terephthalate. Examples of the copolyamide include hot melt copolyamide adhesives available from EMS-Griltex® of Switzerland. Examples of the copolyester include hot melt copolyester adhesives available from EMS-Griltex® of Switzerland. Combinations are possible.

Non-limiting examples of copolyamide hot melt adhesives include Griltex® copolyamides 1A, 2A, 2A P 0-63, 4A, 11A, D1556A, D1321A (heat stabilized), D1321A (heat stabilized), D1564A (heat stabilized), and mixtures thereof. The copolyamide reinforcing composition may have a melting range ranging from 105-150° C., which includes 105, 110, 115, 120, 125, 130, 135, 140, 145, 150° C., and all values and subranges therebetween.

Non-limiting examples of copolyester hot melt adhesives include Griltex® copolyesters 6E, 9E, D1309E, D1365E, D1441E, D1442E, D1502E, D1533E, and mixtures thereof. The copolyester reinforcing composition may have a melting range ranging from 105-190° C., which includes 105, 107, 110, 115, 118, 120, 123, 125, 130, 135, 140, 145, 150, 155, 160, 165, 170, 175, 180, 185, 190° C., and all values and subranges therebetween.

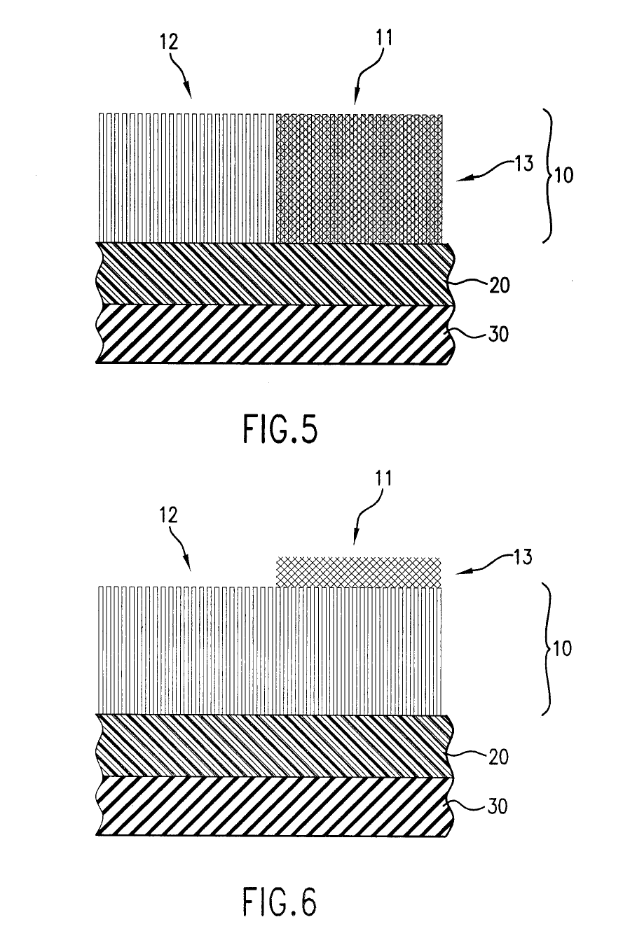

The first upper surface portion 11 may have the same or different vertical elevation as the second upper surface portion 12 in the pile layer 10. It may be indented, such as shown in FIGS. 1-3, 7, and 9, or it may be at the same or substantially the same level, such as shown in FIGS. 4, 5, 8, and 10, or it may have a level that is higher than that of the second upper surface portion, such as shown in FIG. 6, or a combination thereof. As used herein, relative terms such as upper and lower are defined with respect to the floor covering as it might rest on a floor, the floor being lowermost. Similarly, the terms back, backing, etc., are defined with respect to the wearing surface, or the front, of the floor covering.

The floor covering may be tufted, woven, bonded, needle punched or the like, and may be backed or unbacked. In one embodiment, the floor covering may have any carpet construction. For example, it may be cut pile carpet, plush carpet, frieze carpet, saxony carpet, textured carpeting, loop pile carpet, cut and loop pile carpet, or a combination thereof.

The pile layer 10 may be formed from fibrous material. The pile fibers may be natural, synthetic, or a combination thereof. Synthetic fibers include polyamide fibers such as nylon, nylon 6, nylon 66, polyester, acrylic, polyolefin, polypropylene, polyethylene, recycled fiber, thermoplastic polymer, thermoset polymer, copolymers thereof, blends thereof, or a combination thereof. Natural fibers include wool, silk, rayon, cotton, or a combination thereof.

If present, the backing layer 20 may include one or both of a primary backing and a secondary backing. Non-limiting examples of primary backing materials include woven polypropylene, slit film, non-woven, polypropylene, polyester, polyolefin, or combinations thereof. Examples of secondary backing materials include woven leno weave polypropylene, non-woven, polypropylene, polyester, polyolefin, woven jute, fiberglass reinforcement, spunbond substrate, or a combination thereof. In one embodiment, the primary backing supports the pile layer 10, and the secondary backing contacts the back of the primary backing. One or both of the primary and secondary backings may optionally include a backcoating on the lowermost surfaces thereof. Non-limiting examples of a backcoating material may include synthetic SBR latex, polyurethane, polyvinyl acetate, ethylene vinyl acetate, polyvinyl chloride, amorphous resin, thermoplastic polyolefin, or a combination thereof. In one embodiment, one or both of the primary and/or secondary backing is made from CYCLEBAC®, a closed loop 100% recyclable floor mat made from polyolefin fibers available from Racemark International.

If present, the base layer 30 may be made of a polymeric material, for example an elastomeric or thermoplastic material. Examples of materials for the base layer 30 include, but are not limited to thermoplastic materials, elastomeric materials, heat curable elastomeric materials, vulcanizable elastomers made by a sulfur reaction mechanism or a metallic oxide mechanism, synthetic rubber, natural rubber, butadiene polymer, butadiene copolymer, styrene-butadiene rubber, polybutadiene rubber, isoprene polymer, isoprene copolymer, chloroprene rubber, neoprene, nitrile rubber, butyl rubber, ethylene-propylene rubber, polyvinyl chloride, polyethylene, ethylene vinyl acetate, polypropylene, polystyrene, polyurethane, thermoplastic rubber, silicone, copolymers thereof, blends thereof, NSF foam, sodium silicate foam rubber, or combination thereof.

The pile layer 10 may be supported by, bonded to, and/or in contact with either or both of the backing layer 20 and/or base layer 30.

To help prevent the floor covering from moving or shifting, for example, due to the action of feet, the floor covering and/or base layer 30 may include one or more anti-slip or anchoring features. Some examples of these features include hooks, snap fasteners, Velcro™ strips, polyurethane foam floor-contacting surface, NSF foam backing, sodium silicate foam rubber backing, textured surface, one or more downwardly extending projections or “nibs” protruding from the floor contacting surface, hook and nib, hook and loop, a tacky adhesive on the floor contacting surface, flocking, and the like, or a combination thereof. In one embodiment, a passive retention system is used. One example of a passive retention system is the MAT-LOCO floor mat retention system available from Racemark International. Other anti-slip designs are disclosed in U.S. Pat. No. 6,238,765, the entire contents of which being hereby incorporated by reference.

The floor covering may have a tufted carpet construction. Tufted carpet floor coverings may include a backing layer 20 having a primary backing and a secondary backing. Examples of primary backing materials include woven polypropylene, slit film, non-woven, polypropylene, polyester, polyamide, or combinations thereof. Examples of secondary backing materials include woven leno weave polypropylene, non-woven, polypropylene, polyester, polyamide, woven jute, fiberglass reinforcement, felt, rubber or a combination thereof. One or both of the primary and secondary backing materials may be backcoated. Examples of a backcoating material may include synthetic SBR latex, polyurethane, polyvinyl acetate, ethylene vinyl acetate, polyvinyl chloride, amorphous resin, thermoplastic polyolefin, adhesive, or a combination thereof.

In one embodiment, the floor covering has a tufted carpet construction in which the pile material is stitched into an existing backing material, for example a synthetic product, and held in place with an adhesive, for example a latex adhesive. A second layer of backing material may be applied to the latex for greater structural strength.

In one embodiment, the floor covering has a tufted carpet construction having a pile layer 10, a backing layer 20 including a primary backing, a secondary backing, and a bonding agent interposed between the primary and secondary backing.

In another embodiment, the floor covering has a tufted carpet construction having a pile layer 10, a backing layer 20 including a primary backing, and a base layer 30 or cushion attached to the primary backing.

The floor covering may be woven. Woven floor coverings may be constructed of yarns such as, cotton, jute, polypropylene, polyester, polyamide, viscose rayon, blends thereof, or combinations thereof. They may be backcoated with one or more of synthetic SBR latex, polyurethane, polyvinyl acetate, ethylene vinyl acetate, polyvinyl chloride, amorphous resins, thermoplastic polyolefin, adhesive, or a combination thereof.

The floor covering may be bonded. Bonded carpet floor coverings may have a fiberglass matting backing, and may be backcoated with polyvinyl chloride.

The floor covering may be needlepunched. Needlepunched carpet floor coverings may be backcoated with SBR latex, acrylic, ethylene vinyl acetate, SBR latex foam, or a combination thereof.

In one embodiment, the first upper surface portion 11 is formed by a process in which one or both of copolyamide and copolyester is contacted with an uppermost surface of the pile layer 10 or serged area. In one embodiment, the first upper surface portion 11 is formed by a process in which one or both of the copolyamide and copolyester is contacted with any portion of the pile layer 10. In one embodiment, the first upper surface portion 11 is formed by a process in which one or both of the copolyamide and copolyester is contacted with any portion along the length of the vertical thickness of pile layer 10.

The pile layer 10 may be part of a completed or unfinished floor covering. The copolyamide and/or copolyester at this point may be referred to as uncured (even though it may contain polymerized and/or unpolymerized copolyamide and/or copolyester) and may be in the form of a powder, granulate, film, tape, liquid, emulsion, or solution form. The copolyamide and/or copolyester may be applied to specific portions of the pile layer 10, e.g., by rolling, brushing, injection, screen print, drop coating, direct application, extrusion, spray, or electrostatic process, vibration, capillary action, or a combination thereof. In one embodiment, the copolyamide and/or copolyester may be applied to a portion of the pile layer 10 already formed on the backing layer 20. In one embodiment, the copolyamide and/or copolyester may be applied to the backing layer 20 in advance of contacting the backing layer 20 with the pile layer 10. In one embodiment, the application of the copolyamide and/or copolyester to the pile layer 10 which is already formed on a backing layer 20 can be carried out by rolling, brushing, injection, screen print, drop coating, direct application, extrusion, spray, or electrostatic process, vibration, capillary action, or a combination thereof. In one embodiment, the application of the copolyamide and/or copolyester to the backing layer 20 can be carried out by rolling, brushing, injection, screen print, drop coating, direct application, extrusion, spray, or electrostatic process, vibration, capillary action, or a combination thereof.

In one embodiment, a powder form of copolyamide and/or copolyester reinforcing composition may be initially applied to the surface of the pile layer 10 using a screen print machine, such as available from Hebbecker International of Germany.

In one embodiment, the copolyamide and/or copolyester may be applied by brushing a powder form of copolyamide and/or copolyester into or onto the pile layer 10. In one embodiment, the copolyamide and/or copolyester may be applied by brushing a powder form of copolyamide and/or copolyester into or onto the pile layer 10 and allowing it or causing it to migrate to any portion along the vertical thickness of the pile layer 10.

In one embodiment, a powder form of the copolyamide and/or copolyester reinforcing composition is applied using a brush process to press the powder, originally applied to the uppermost portion of the pile layer 10 where the first upper surface portion 11 is desired to be formed, to a desired location along the length of the vertical thickness of the pile layer 10. The brushes may be suitably selected to allow the pile to move apart and the pile fibers or yarn to open so that the powder can fall down into the pile as low as possible. The brush may be suitably vibrated using different cycles. In one embodiment, the brush is vibrated using a small amplitude at the beginning so that the powder begins to penetrate the pile in the desired location or pattern and without spreading out upon the surface of the pile layer 10, then, once the powder has disappeared into the pile surface, a larger amplitude of vibration may be used with the goal of causing the powder to fall down into the pile layer 10 as far as possible. In one embodiment, using this technique, the powder is brushed down as far as possible into the pile layer 10. In another embodiment, using this technique, the powder is brushed down at a location anywhere along the length of the vertical thickness of the pile layer 10. One or both of the vibration cycles may be applied for fifteen seconds. Suitable examples of brush vibrating devices are available from Hebbecker International of Germany.

In one embodiment, a film of the copolyamide and/or copolyester is applied directly to the backing layer 20 to make a coated backing; the pile layer 10 is then tufted onto or contacted with the coated backing; and then a hot press is applied to form the first upper surface portion 11 of the pile layer 10. For example, a film of the copolyamide and/or copolyester is applied directly to a primary cloth to make a coated primary; the pile layer 10 is then tufted onto or contacted with the coated primary; and then a hot press is applied to form the first upper surface portion 11 of the pile layer 10.

The thus-applied copolyamide and/or copolyester may be melted or partially or completely liquefied by the application of an activation energy such as radio-frequency (RF) energy, ultrasonic energy, heat energy, infrared (IR) radiation, ultra-violet (UV) radiation, or a combination thereof to the copolyamide and/or copolyester. The melted or partially liquefied copolyamide and/or copolyester contacts and/or penetrates the fibers in the pile layer 10, serging and/or serge area, or a combination thereof. In one embodiment, an RF activation energy of 20 kW is applied.

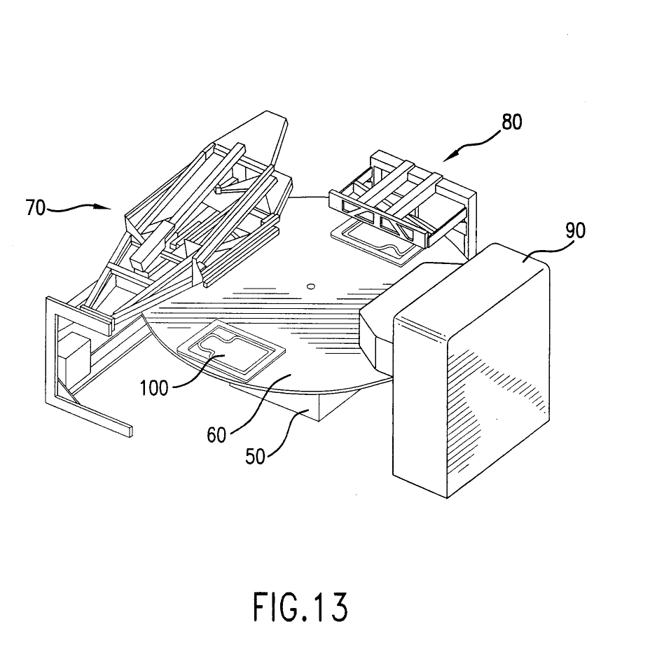

Suitable examples of RF welding machines include those available from Thermatron in the U.S. One example of which is the Thermatron 20 kW type F20-30. The process may be suitably automated. One example of an automated system is shown in FIG. 13. A rotating carousel 60 is supported by a base 50. As the carousel 60 rotates clockwise, the workpiece floor covering is initially screen printed with powder using the screen print application robot 70, then brushing and vibration on machine 80, and RF curing and optionally pressing with an RF machine 90 to produce the mat 100.

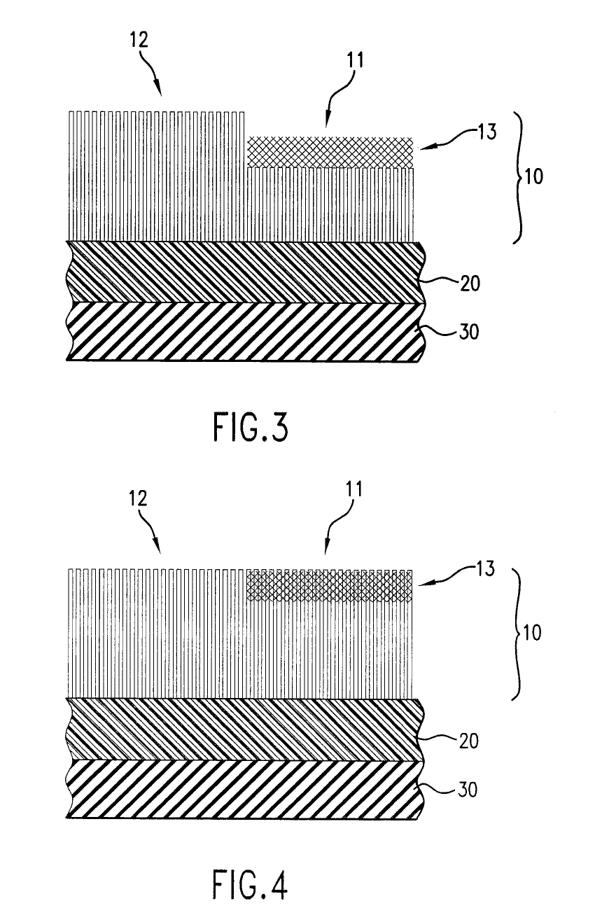

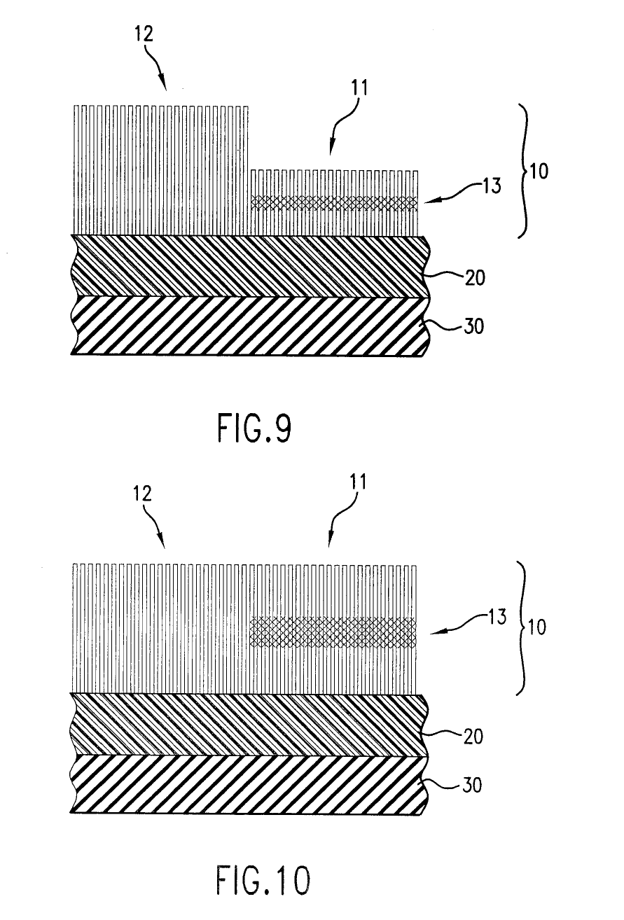

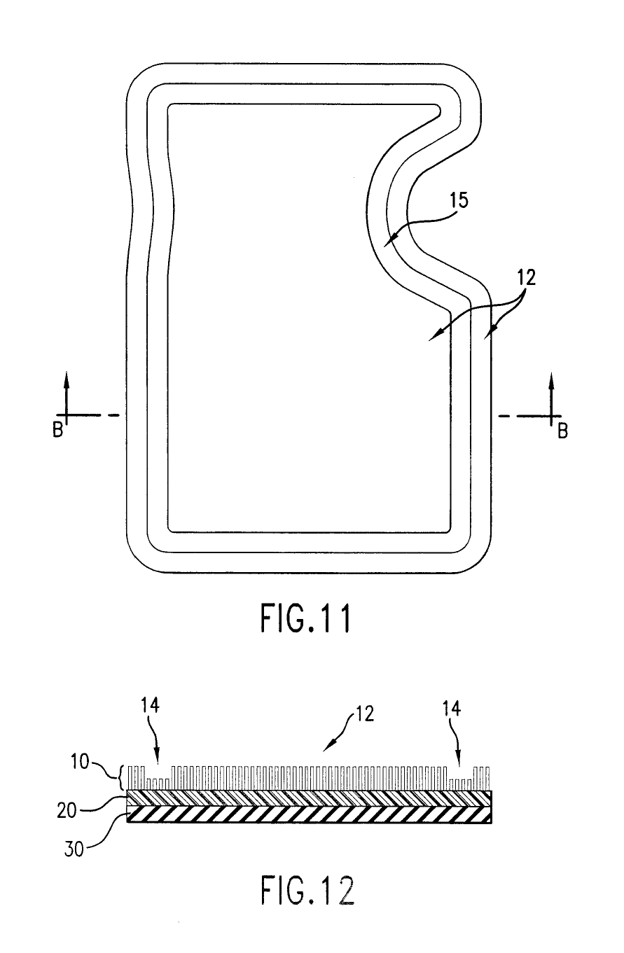

The copolyamide and/or copolyester is then allowed to cure, e.g., harden, polymerize, crosslink, or a combination thereof, such that it binds the pile fibers together to form a bound portion 13 and the first upper surface portion 11 or binds the serge fibers together to form a reinforced serged edge. In one embodiment, the first upper surface portion 11 includes a combination of pile fibers bound or adhered together with the polymerized copolyamide and/or copolyester. In the first upper surface portion 11, the bound fibers in the bound portion 13 may be directionally oriented, they may be disoriented, or they may be tangled, or a combination thereof. In the first upper surface portion 11, the bound portion 13 which contains the cured reinforcing composition may extend throughout the vertical thickness of the pile layer 10 (e.g., FIGS. 2 and 5), or the bound portion 13 may exist on or at the surface of the pile layer 10 (e.g., FIGS. 3 and 6), near the surface of the pile layer 10 (e.g., FIGS. 1 and 4), in the center of the pile layer 10 (e.g., FIGS. 9 and 10), near the lower portion of the pile layer 10 (e.g., FIGS. 7 and 8), or a combination thereof. In one embodiment, the bound portion 13 may exist anywhere along the length of the vertical thickness of the pile layer 10. In one embodiment, the pile layer 10 may have a density that is constant or varying along the length of its vertical axis, optionally due to bound portion 13. The density may correspond to varying amounts of reinforcing composition. The reinforcing composition my be suitably applied in varying amounts anywhere along the length of the vertical axis of the pile layer 10.

In the process, some or all or none of the pile fibers in the first upper surface portion 11 melt or partially melt during the application of energy. In one embodiment, none of the pile fibers melt during the process. In one embodiment, a plurality of the pile fibers melt when the activation energy is applied. In one embodiment, a majority of the pile fibers melt while the activation energy is applied. Similarly, some, none, or all of the fibers in the serging yarn or serge area melt or partially melt during the application of energy.

In one embodiment, the activation energy is applied while pressing the portion of the pile layer 10 to form the first upper surface portion 11. In one embodiment, the activation energy is applied before pressing the portion of the pile layer 10 that will become the first upper surface portion 11. In one embodiment, the activation energy is applied after pressing the portion of the pile layer 10 that will become the first upper surface portion 11. Hot pressing or cold pressing may be used. The serged area may be similarly pressed or not pressed. In one embodiment, the pile layer 10 or serging is not pressed. In one embodiment, the application of RF energy includes RF welding.

The floor covering may include an indented portion 14, or “stone collector” or channel 15 therein. See, e.g., FIGS. 1, 2, 3, 7 and 9. Through pressing, the first upper surface portion 11 may form an indented portion 14 (See, e.g., FIG. 1) in the pile layer 10. One or more indented portions 14 may be present in one or more parts of the pile layer 10. The indented portion 14 may be patterned in one or more portions of the floor covering, and the pattern may or may not be designed to direct dirt and small stones to one or more specific portions of the floor covering. In one embodiment, the indented portion 14 may form a channel 15 that runs around the perimeter or set back a distance from the perimeter of the floor covering. In one embodiment, the indented portion 14 forms a channel 15 that outlines or encompasses an area within the floor covering, wherein the area has a shape and/or size that is different than that of the outline formed by the perimeter of the floor covering. The indented portion 14 and/or channel 15 formed from the first upper surface portion 11 pressed down into the floor covering may act as a stone collector or dirt channel, which retains dirt, small stones, mud, liquid and the like before they fall down on the carpeting, e.g., in the floor of a automobile or other conveyance.

One embodiment of the floor covering includes a heel pad, which may be suitable for automobile applications, such as a floor mat. One example of a heel pad and method of making is disclosed in U.S. Pat. No. 5,938,873, the entire contents of which are hereby incorporated by reference. Another embodiment includes a floor covering having a reinforced heel area and/or a reinforced area for the heel pad, wherein the reinforced part includes the first upper surface portion 11. In one embodiment, the indented portion 14 forms a channel 15 that outlines or encompasses the heel area, reinforced heel area, and/or reinforced heel pad area. In one embodiment, the indented portion 14 forms a channel 15 that outlines or encompasses the heel area, reinforced heel area, and/or reinforced heel pad area, wherein the area has a shape and/or size that is different than that of the outline formed by the heel area, reinforced heel area, and/or reinforced heel pad area.

The indented portion 14 and/or channel 15 may have any profile in cross section, which may be pressed using one or more pressing devices, such as a horn or molding tool. The pressing devices may have a shape chosen to impart a particular profile to the indented portion 14 and/or channel 15. Nonlimiting examples of profiles include square shaped (such as shown in FIG. 8), semicircle, concave, convex, triangular, sawtooth, comblike, and the like, and any combination thereof.

In one embodiment, a copolyamide and/or a copolyester powder, granulate or as film is applied prior to pressing and heating the carpet pile with RF, heat, ultra-sonic, IR, or UV energy.

The serging yarn binds the edge of the floor covering. The serging yarn may be natural, synthetic, or a combination thereof. Synthetic fibers include polyamide fibers such as nylon, nylon 6, nylon 66, polyester, acrylic, polyolefin, polypropylene, polyethylene, recycled fiber, thermoplastic polymer, thermoset polymer, copolymers thereof, blends thereof, or a combination thereof. Natural fibers include wool, silk, rayon, cotton, or a combination thereof.

One embodiment includes a floor covering having one or more edges serged with reinforced serging yarn, wherein the serging yarn is reinforced with the copolyamide and/or copolyester.

One embodiment includes a floor covering having a reinforced serging yarn at the edges thereof using the copolyamide and/or copolyester, wherein the copolyester and/or copolyamide is applied to the serging yarn or serged area before serging occurs. One embodiment includes a floor covering having at least a first upper surface portion 11 and a second upper surface portion 12 in combination with a serged edge serged with reinforced serging yarn, wherein the serging yarn is reinforced with copolyamide and/or copolyester before serging occurs.

One embodiment includes a floor covering having a reinforced serging yarn at the edges thereof using the copolyamide and/or copolyester, wherein the copolyester and/or copolyamide is applied to the serging yarn or serged area after serging occurs.

One embodiment includes a floor covering having a reinforced serging yarn at the edges thereof using the copolyamide and/or copolyester, wherein the copolyester and/or copolyamide is applied to the serging yarn before serging occurs. In this embodiment, the serging yarn is contacted with uncured copolyamide and/or copolyester, The copolyamide and/or copolyester at this point may be in the form of a powder, granulate, film, tape, liquid, emulsion, or solution form. The copolyamide and/or copolyester may be applied to all of or select portions of the serging yarn, e.g., by a rolling, brushing, immersion bath, screen print, drop coating, direct application, extrusion, spray, or electrostatic process, or a combination thereof. If appropriate, the thus-applied copolyamide and/or copolyester may be melted or partially or completely liquefied by the application of an activation energy such as radio-frequency (RF) energy, ultrasonic energy, heat energy, infrared (IR) radiation, ultra-violet (UV) radiation, or a combination thereof to the copolyamide and/or copolyester. The melted or partially liquefied copolyamide and/or copolyester contacts and/or penetrates the fibers in the serging yarn.

The copolyamide and/or copolyester is then allowed to cure, e.g., harden, polymerize, crosslink, or a combination thereof, such that it binds the serging yarn fibers together to form a reinforced serging yarn. The floor covering is then serged with the reinforced serging yarn. A reinforced serged edge which resists rubbing and wear may be formed in this manner.

In one embodiment, the process results in a floor covering having a portion thereof wherein the fibers are bound together forming a wear resistant and dense area in the pile layer 10. It is possible to form reinforced areas in the pile layer that resist rubbing and wear.

As seen in FIG. 13, the perspective drawing shows an HF welding machine in which an RF machine 90 is mounted on a carousel 60 to press down the carpet pile. The screen print applicator robot 70 suitably applies powder on the mat, e.g., onto the area which will become the stone collector prior to the RF process. The applicator robot 70 may apply the uncured, powdered reinforcing composition with “wipers” running on a print screen that limits the powder to given areas of the pile layer 10.

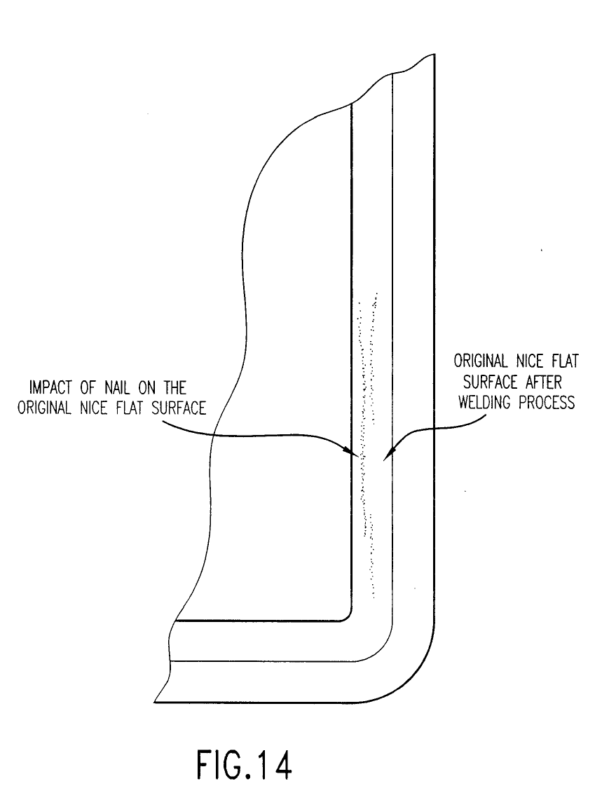

As shown in FIG. 14, a floor covering was prepared by hot pressing a channel into a pile layer 10 without the use of copolyamide and copolyester. The thus-prepared channel was rubbed with a nail. As seen in FIG. 14, the rubbing caused the pile fibers to lift up in the channel and show wear, which is undesirable. One embodiment of the present invention overcomes this problem and provides a wear resistant channel or indentation surface. In part, the reinforcing copolyamide and/or copolyester composition binds the pile fibers together such that they resist abrasion, and maintain their surface finish.

One embodiment includes the use copolyamide or copolyester for floor mat, car floor carpet and/or trim applications (together with the heat activation process) in order to reinforce/bind the fibers.

One embodiment includes applying the uncured reinforcing composition in the form of a powder onto an area of a pile layer 10, heating and melting the powder with IR energy, allowing the heated, melted powder to penetrate the pile layer 10, and allowing the melt to cool and/or cure to bind the fibers of the pile layer 10 together in a bound portion 13 to form a first upper surface portion 11.

One embodiment provides a floor covering, which includes at least one pile layer 10, wherein the pile layer fibers are copolyamide-containing fibers, that includes at least a first upper surface portion 11 in which a plurality of pile layer fibers are in contact with a reinforcing composition that includes polymerized copolyamide, or a combination of polymerized copolyamide and polymerized copolyester; and at least a second upper surface portion 12 in which a plurality of the copolyamide-containing pile layer fibers are not in contact with the reinforcing composition.

One embodiment provides a floor covering, which includes at least one pile layer 10, wherein the pile layer fibers are polyethylene, polyolefin, and/or copolyester-containing fibers, that includes at least a first upper surface portion 11 in which a plurality of pile layer fibers are in contact with a reinforcing composition that includes polymerized copolyester, or a combination of polymerized copolyester and polymerized copolyamide; and at least a second upper surface portion 12 in which a plurality of the polyethylene, polyolefin, and/or copolyester-containing pile layer fibers are not in contact with the reinforcing composition.

One embodiment includes the use of both RF welding and screen print powder application to affect the penetration of the uncured copolyamide or copolyester into the pile fibers and bind them together.

One embodiment includes reinforcing carpet (or serging yarn) fibers by using a copolyamide or copolyester (in any form—powder, granulate or liquid).

The floor covering may optionally include an antimicrobial to reduce the growth of common bacteria, fungi, yeast, mold and mildew. The floor covering may optionally include an antistatic to dissipate an electrostatic charge.

1. A floor covering, comprising:
at least one pile layer comprising:
at least a first upper surface portion in which a plurality of pile layer fibers are in contact with a reinforcing composition comprising polymerized copolyamide, polymerized copolyester, or a combination thereof; and
at least a second upper surface portion in which a plurality of pile layer fibers are not in contact with the composition.

2. The floor covering of claim 1, wherein the first upper surface portion forms an indented or channel portion in the pile layer.

3. The floor covering of claim 1, wherein the first upper surface portion has a first height, the second upper surface portion has a second height, and the second height is greater than the first height.

4. The floor covering of claim 1, wherein the first upper surface portion forms a patterned channel in at least a portion of the pile layer.

5. The floor covering of claim 1, wherein the composition comprises polymerized copolyamide.

6. The floor covering of claim 1, wherein the composition comprises polymerized copolyester.

7-9. (canceled)

10. The floor covering of claim 1, which is an automotive floor mat.

11. The floor covering of claim 1, wherein the first upper surface portion has a first density, the second upper surface portion has a second density, and the first density is greater than the second density.

12-14. (canceled)

15. A process, comprising:
contacting at least a first upper surface portion of a pile layer with at least one uncured copolyamide, copolyester, or a combination thereof;
applying at least one activation energy to the uncured copolyamide, copolyester, or a combination thereof; and
curing the uncured copolyamide, copolyester, or a combination thereof to form at least an upper surface portion in which a plurality of pile layer fibers are in contact with polymerized copolyamide, polymerized copolyester, or a combination thereof.

16. The process of claim 15, wherein the process comprises keeping a second upper surface portion of the pile layer free from contact the with uncured copolyamide, copolyester, or a combination thereof.

17. The product of claim 15, wherein the process further comprises heat pressing the first upper surface portion.

18. A floor covering, comprising:
at least one pile layer comprising a serged edge;
wherein the serged edge is in contact with a reinforcing composition comprising polymerized copolyamide, polymerized copolyester, or a combination thereof.

19. The floor covering of claim 18, wherein the serged edge comprises an upper wearing surface, and at least a portion of the upper wearing surface is in contact with the reinforcing composition.

20. The floor covering of claim 18, wherein the composition comprises polymerized copolyamide.

21. The floor covering of claim 18, wherein the composition comprises polymerized copolyester.

22-24. (canceled)

25. The floor covering of claim 18, which is an automotive floor mat.

26-27. (canceled)

28. A process, comprising:
contacting a serged edge of a floor covering with a reinforcing composition comprising uncured copolyamide, uncured copolyester, or a combination thereof;
applying at least one activation energy to the uncured copolyamide, copolyester, or a combination thereof; and
curing the uncured copolyamide, copolyester, or a combination thereof.

29. (canceled)

30. A process, comprising:
contacting a serging yarn with a reinforcing composition comprising uncured copolyamide, uncured copolyester, or a combination thereof;
applying at least one activation energy to the uncured copolyamide, copolyester, or a combination thereof; and
curing the uncured copolyamide, copolyester, or a combination thereof;
to produce a reinforced serging yarn.

31. The process of claim 18, further comprising serging one or more edges of a floor covering with the reinforced serging yarn.

32-33. (canceled)
